(19) United States
(12) Patent Application Publication
(10) Pub. No.: US 2004/0103552 A1
(43) Pub. Date: Jun. 3, 2004

(54) Centrifugal device for washing and drying salads and the like

(76) Inventor: Renato Rhon, Omegna (IT)

Correspondence Address: SUGHRUE MION, PLLC, 2100 PENNSYLVANIA AVENUE, N.W., SUITE 800, WASHINGTON, DC, 20037, US

(21) Appl. No.: 10/467,692

(22) PCT Filed: Feb. 7, 2002
(86) PCT No.: PCT/IB02/00366

(30) Foreign Application Priority Data
Feb. 8, 2001 (IT) T02001U000019

(51) Int. Cl. F26B 17/24

(52) U.S. Cl. 34/58

(57) ABSTRACT

The centrifuge (1) comprises a container (2) which is open at the top, a perforated basket (3) which is rotatable in the container (2) and which is likewise open at the top, a lid (4) which can be coupled to the container (2), a drive member (5) which is rotatable relative to the lid (4) and which is capable of being coupled to the basket (3) and of driving it in rotation, and an operating unit (6) comprising an electrical motor (10), capable of bringing about the rotation of the drive member (5) and of the basket (3) coupled thereto. The operating unit (6) is separate and distinct from the lid (4) and is capable of being inserted removably into a housing (4a) provided in the lid (4) in such a manner that it is coupled in rotation to the drive member (5). The operating unit (6) also comprises at least one electrical battery (15), preferably of the rechargeable type, for supplying power to the motor (10).

The present invention relates to a centrifuge for drying salad and the like.

More specifically, the invention relates to a centrifuge of the type comprising

a container which is open at the top,

a perforated basket which is rotatable in the container and which is likewise open at the top,

a lid which can be coupled to the container,

a drive member which is rotatable relative to the lid and which is capable of being coupled to the basket and of driving it in rotation, and

an operating unit comprising an electrical motor, capable of bringing about the rotation of the drive member relative to the lid and of the basket relative to the container.

U.S. Pat. No. 5,054,209 describes and illustrates a centrifuge of that type for drying salad and the like, in which the operating unit comprises an electrical motor which is permanently secured to the lid. In a first embodiment illustrated in that United States patent, the electrical motor is secured on the lid in a position such that its shaft extends substantially parallel with the lid and is coupled to the rotatable drive member by way of a kinematic transmission which includes a bevel gear pair.

In a second embodiment illustrated in that earlier patent, the electrical drive motor is permanently secured to the lid in a position such that its shaft is substantially at right-angles to the lid.

The centrifuge known from the earlier United States patent has various disadvantages.

In the first place, since the electrical drive motor is permanently coupled to the lid and to the drive member for the basket of the centrifuge, it cannot be used for other purposes but, rather, is intended unequivocally for use in operating the centrifuge.

In addition, because the electrical motor is to be supplied with power by cable connection to the electrical mains, it may involve safety problems for the user.

An object of the invention is therefore to provide a centrifuge of the type specified above for drying salad and the like, which enables the disadvantages outlined above of the solutions according to the prior art to be avoided.

That object is achieved according to the invention with a centrifuge of the above-mentioned type, characterized in that the above-mentioned operating unit is separate and distinct from the lid and is capable of being inserted removably into a housing provided in the lid in such a manner that it is releasably coupled in rotation to the drive member; the operating unit also comprising at least one electrical battery, preferably of the rechargeable type, for supplying power to the motor.

According to a further characteristic of the invention, the operating unit comprises circuit means for controlling the electrical motor, which means can be activated by a manually operated switch and are capable of bringing about selectively the rotation of the motor in a predetermined direction at a relatively high speed or in both directions alternately, at a relatively low speed.

As will emerge more clearly hereinafter, owing to those characteristics, a centrifuge according to the invention is suitable not only for use in drying salad and the like but also for carrying out a true washing operation.

Further characteristics and advantages of the invention will emerge from the following detailed description, which is given purely by way of non-limiting example, with reference to the appended drawings in which:

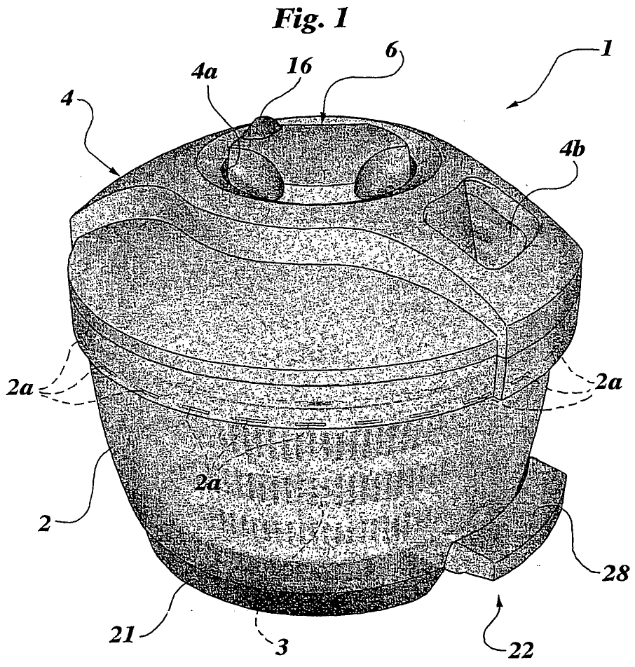

FIG. 1 is a perspective view of a centrifuge according to the invention;

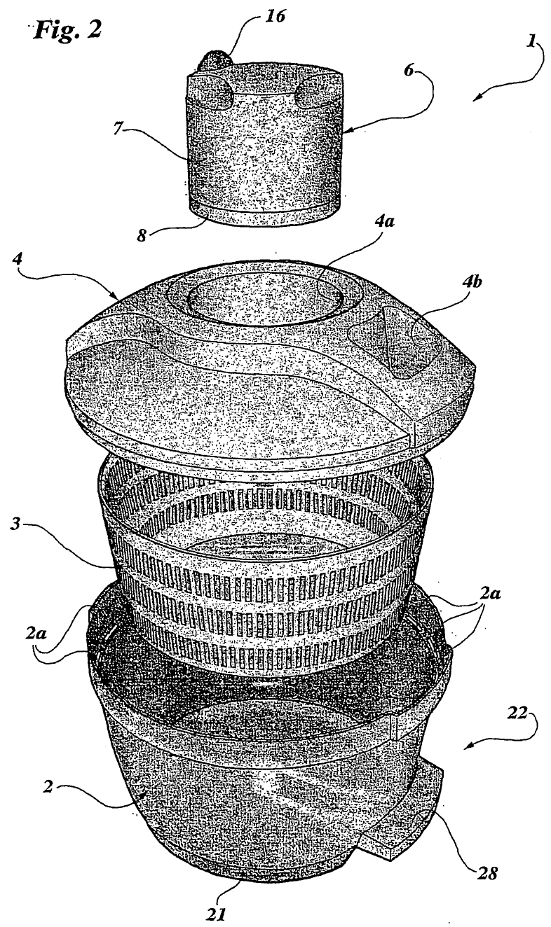

FIG. 2 is an exploded perspective view of the centrifuge shown in FIG. 1;

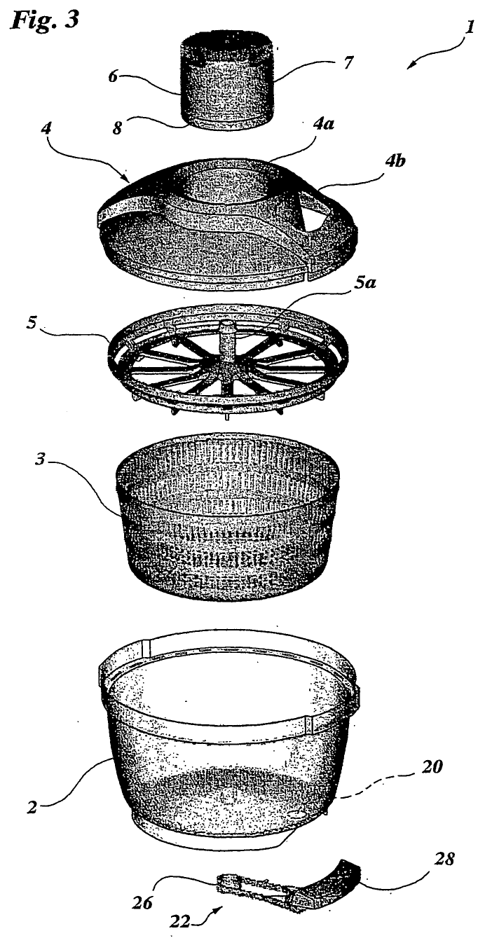

FIG. 3 is a further exploded perspective view of the centrifuge shown in the previous Figures;

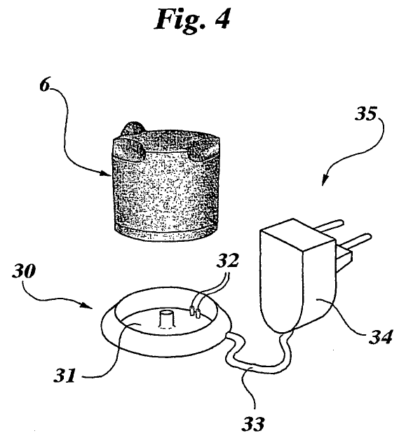

FIG. 4 is a perspective view of an operating unit including an electrical motor, and of an associated device for supplying electrical power;

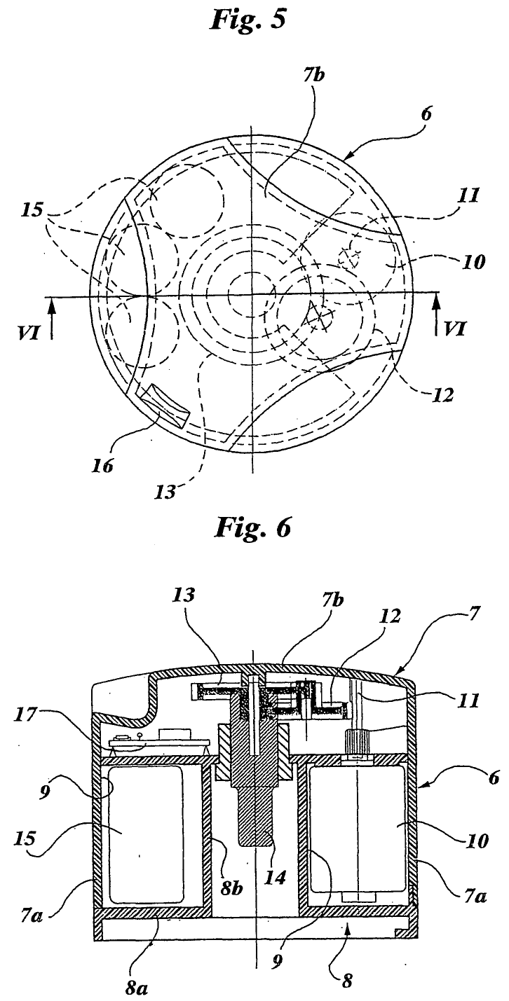

FIG. 5 is a top plan view of an operating unit for a centrifuge according to the invention;

FIG. 6 is a sectional view taken on the line VI-VI of FIG. 5; and

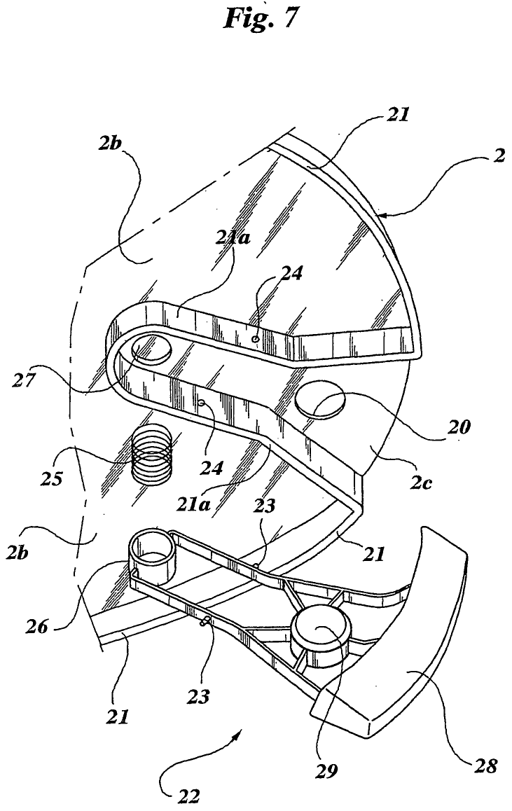

FIG. 7 is a perspective view showing a control device having a ever for controlling a discharge opening of a centrifuge according to the invention.

In FIGS. 1 to 3, a centrifuge for washing and drying salad and the like, which is produced in accordance with the present invention, is generally indicated 1.

The centrifuge 1 comprises a container 2 which is open at the top and which is produced, for example, from an opaque or at least partially transparent plastics material.

A perforated basket 3, which is likewise open at the top, is mounted rotatably in the container 2. Advantageously the basket is also produced, for example, from a plastics material.

The centrifuge 1 also comprises a lid which is generally indicated 4 and which can be coupled to the container 2. The lid is likewise advantageously produced from opaque or at least partially transparent moulded plastics material and has a substantially circular central opening 4a and (at least) one off-centre opening 4b, the functions of which will be described hereinafter.

Referring to FIG. 3, the centrifuge 1 also comprises a drive member 5 which, in the embodiment, is, by way of example, substantially in the form of spoked wheels, with a central tubular hub 5a projecting upwards. The drive member 5, which is rotatable relative to the lid 4, is, in a manner known per se, capable of being coupled to the basket 3 and of driving it in rotation.

Finally, the centrifuge 1 comprises an operating unit which is generally indicated 6 in FIGS. 1 to 6.

Referring to FIGS. 5 and 6, the operating unit comprises a support casing comprising a body 7 which is substantially in the form of an inverted beaker and which has a substantially cylindrical lateral surface 7a. Coupled at the bottom to the mouth of the body 7 is a base 8 (FIG. 6) comprising an external annular rim 8a which is connected to a central cylindrical tubular protuberance 8b.

Defined between the lateral wall 7a of the body 7 and the wall of the protuberance 8b of the base 8 is an annular chamber 9 which accommodates an electrical control motor 10 whose shaft 11 is directed vertically and is coupled by way of a gear train 12 and 13 to an output shaft 14. As shown in FIG. 6, the shaft 14 projects into the cavity or passage defined in the tubular protuberance 8b of the base 8.

Three batteries 15 (FIGS. 5 and 6) which are advantageously of the rechargeable type and which are used to supply power to the electrical motor 10 are also accommodated in the annular chamber 9 defined above.

A manually operated electrical switch 16 (FIGS. 1, 2 and 5) which is advantageously of the type having three positions is mounted in a suitable opening provided in the top wall 7b of the body 7.

The switch may optionally be mounted at the centre of the top wall 7b of the body 7.

At least one circuit board 17 (FIG. 6) carrying the components of a circuit for controlling the functioning of the electrical motor 10 is also accommodated inside the casing of the operating unit 6. The circuit is connected to the switch 16.

The operating unit 6 which, according to the invention, is advantageously separate and distinct from the lid 4 of the centrifuge, is capable of being inserted in a removable manner into the opening 4a in the lid in such a manner that it is coupled in rotation to the drive member 5. The coupling in rotation is effected, in particular, as a result of the coupling between the tubular hub 5a of the drive member 5 and the output shaft 14 of the operating unit. When the operating unit 6 is inserted into the corresponding opening 4a in the lid 4, the tubular hub 5a of the drive member 5 penetrates into the appendage 8b of the operating unit and is coupled to the output shaft 14.

As mentioned above, the manually operated switch 16 is advantageously of the type having three positions.

A first position, or resting position, corresponds to the inactive state of the electrical motor 10.

The switch 16 can be switched from that position into a first working position in which the control circuit associated with the electrical motor 10 brings about the rotation of the motor in both directions alternately, at a low speed (washing speed).

The switch 16 can also be placed in a second working position in which the control circuit of the electrical motor 10 brings about the rotation of the motor continuously in a predetermined direction, at a relatively high speed (centrifugation speed).

As can be seen more clearly in FIG. 1, the container 2 has, in the vicinity of its upper edge, a plurality of overflow openings 2a which are substantially at the same predetermined level.

Referring to FIG. 7, which is a partial perspective view of the container 2 from below, with parts shown in exploded form, the bottom wall 2b of the container 2 has a discharge opening indicated 20.

A rim 21 extends downwards from the periphery of the bottom wall 2b of the container 2. The discharge opening 20 is formed in a portion 2c of the bottom wall of the container 2, which portion is surrounded by a portion 21a of the above-mentioned rim, the portion 21a having a substantially U-shaped form with divergent distal ends (FIG. 7).

In FIG. 7, 22 indicates a control lever having, in its intermediate portion, a pair of aligned pegs or pins 23 which engage in corresponding openings 24 defined in two facing regions of the portion 21a of the rim 21. The pegs or pins 23 define the pivot axis of the lever 22.

A helical opposing spring 25 is interposed between an end member 26 of the lever 22, which end member is shaped in the form of a beaker, and a seat 27 provided in the portion 2c of the bottom wall of the container 2.

The opposite end of the lever 22, indicated 28 in FIGS. 1 to 3 and 7, projects laterally relative to the base of the container 2.

Between the end portion 28 and the pins 23, the lever 22 has a closure member 29 (FIG. 7) associated with the discharge opening 20 of the container 2.

The arrangement is such that the spring 25 tends to maintain the lever 22 in a position in which the closure member 29 shuts off the discharge opening 20. The discharge opening can also be freed by exerting manual pressure on the end portion 28 of the lever 22, against the action of the opposing spring 25.

The centrifuge described above can be used in the following manner.

The centrifuge 1 can first of all be used for washing salad, green vegetables and the like. To that end, the salad or green vegetables to be washed are placed in the basket 3.

The drive member 5 and the lid 4 are then coupled to the basket 3 and, respectively, to the container 2.

The centrifuge 1 can then be placed in a kitchen sink in such a manner that the opening 4b in the lid 4 is arranged below the water-delivery mouth of a tap. By means of the tap, a stream of water is introduced into the container 2 through the opening 4b in the lid and the openings in the drive member 5.

When the water in the container 2 reaches the level of the overflow openings 2a, it can spill over the outside of the container and into the sink.

The operating unit 6, which has previously been positioned in the opening 4a in the lid 4, can then be operated by means of the switch 16. The switch is located in the working position in which it brings about the operation of the electrical motor 10 alternately in the two opposing directions, at a relatively low speed.

The continuous stream of water, combined with the action of alternating movement conferred on the basket 3, permits an efficient washing action on the salad or the like contained in the basket.

The circuit which controls the electrical motor 10 may advantageously be programmed for a predetermined duration of the stage of washing with alternating motion.

For the washing stage, the user can pour into the container 2 a substance (liquid or pulverulent or solid and soluble) capable of improving the efficiency of the washing action and/or of disinfecting the salad or the like.

When it is considered that the salad or the like has been washed sufficiently, the user turns off the tap and, by means of the switch 16, deactivates the electrical motor 10 of the centrifuge.

The user can then discharge the water contained in the container 2 by pressing manually on the end 28 of the control lever 22 in such a manner as to disengage the closure member 29 from the discharge opening 20 of the container.

When the discharge of water from the container 2 has been completed, the user releases the lever 22 which, under the action of the spring 25, closes the discharge opening 20 again by means of the closure member 29.

At that point, the user can operate the switch 16, placing it in the working position in which it brings about the rotation of the electrical motor 10 continuously in a predetermined direction, at the relatively high centrifugation speed, for drying the salad or other green vegetables which have been previously washed.

After a centrifugation stage, the water yielded from the salad and collected in the container 2 can be evacuated through the discharge opening 20 by pressing on the end 28 of the lever 22.

For better drying, at least a second centrifugation stage may follow the first stage.

During the operation of the centrifuge 1, the operating unit 6 is disconnected from the electrical mains. This ensures safe operation for the user from an electrical point of view.

The operating unit 6 is also disconnectable from the centrifuge 1 and can be used as an operating device in association with other kitchen appliances or utensils. This characteristic is particularly advantageous.

In order to recharge the batteries 15, the operating unit 6 may advantageously be coupled to a terminal board for the supply of electrical power, such as that indicated 30 in FIG. 4. In the embodiment illustrated, the terminal board has an annular seat 31 in which the base of the operating unit 6 can be placed and in which extend electrical contact members 32 which are to be coupled to corresponding terminals of the batteries of the unit 6. The terminals 32 are connected by way of a multipolar cable 33 to a transformer/rectifier unit 34 which is advantageously integrated with a plug 35 insertable into a socket for connection to the electrical mains for supplying alternating current.

1. A centrifuge (1) for drying salad or the like, comprising
a container (2) which is open at the top,
a perforated basket (3) which is rotatable in the container (2) and which is likewise open at the top,
a lid (4) which can be coupled to the container (2),
a drive member (5) which is rotatable relative to the lid (4) and which is capable of being coupled to the basket (3) and of driving it in rotation, and
an operating unit (6) comprising an electrical motor (10), capable of bringing about the rotation of the drive member (5) and of the basket (3) coupled thereto;
the centrifuge being characterized in that the operating unit (6) is separate and distinct from the lid (4) and is capable of being inserted removably into a housing (4a) provided in the lid (4) in such a manner that it is coupled in rotation to the drive member (5); the operating unit (6) also comprising at least one electrical battery (15), preferably of the rechargeable type, for supplying power to the motor (10).

2. A centrifuge according to claim 1, wherein the operating unit (6) comprises a support casing (7, 8) which accommodates the above-mentioned electrical motor (10) and the at least one battery (15), the casing having a cavity (8b) into which an output shaft (14) of the operating unit (6) projects; the drive member (5) having a control shaft (5a) capable of being introduced into the cavity (8b) of the casing (7, 8) of the operating unit (6) in order to be coupled to the output shaft (14) of the unit (6).

3. A centrifuge according to claim 1 or 2, wherein the operating unit (6) comprises circuit means for controlling the motor (10), which means can be activated by a manually operated switch (16) and are capable of bringing about selectively the rotation of the motor (10) in a predetermined direction at a relatively high speed or in both directions alternately at a relatively low speed.

4. A centrifuge according to any one of the preceding claims, provided with a device (30-35) for supplying electrical power which can be connected to the electrical mains and which comprises a base (31) capable of accommodating the operating unit (6) and provided with means (33-35) capable of permitting the recharging of the at least one battery (15) of the operating unit (6) with electrical power supplied from the mains.

5. A centrifuge according to any one of the preceding claims, wherein the lid (4) has at least one opening (4b) capable of permitting the introduction of a stream of water into the container (2) for washing the salad or the like contained in the basket (3).

6. A centrifuge according to claim 5, wherein the container (2) has at least one overflow opening (2a) at a predetermined level.

7. A centrifuge according to claim 5 or 6, wherein the container (2) has, at the bottom, at least one discharge opening (20) with which a removable closure member (29) is associated.

8. A centrifuge according to claim 7, wherein the closure member (29) is connected to a manually operated control lever (22) constrained in a rotatable manner at the bottom wall (2b, 2c, 21a) of the container (2).

9. A centrifuge according to claim 8, wherein the control lever (22) is articulated, at an intermediate portion thereof, to the bottom wall of the container (2), and has an end (28) which projects laterally relative to the container (2) and which can be pressed manually in order to uncouple the closure member (29) from the associated discharge opening (20) in the container (2), against the action of resilient means (25) which cooperate with the other end (26) of the lever (22) and which tend to maintain the lever in a position in which the closure member (29) shuts off the discharge opening (20).
